(19) United States
(12) Patent Application Publication
(10) Pub. No.: US 2025/0238416 A1
(43) Pub. Date: Jul. 24, 2025

(54) CHECKSUM VALIDATION ACROSS DATA TABLES WITH XML AND CLOB FOR A DATABASE UPDATE

(71) Applicant: JPMorgan Chase Bank, N.A., New York, NY (US)

(72) Inventors: Anurag Rastogi, Bournemouth (GB); Arunkumar Mani, Poole (GB); Gopal Arumugam, Bournemouth (GB); Dijesh Raman, Tampa, FL (US); Kevin Lobo, Wimborne (GB)

(73) Assignee: JPMorgan Chase Bank, N.A., New York, NY (US)

(21) Appl. No.: 19/024,653

(22) Filed: Jan. 16, 2025

Related U.S. Application Data
(60) Provisional application No. 63/622,661, filed on Jan. 19, 2024.

(51) Int. Cl. G06F 16/23; G06F 16/242

(52) U.S. Cl. CPC G06F 16/2365; G06F 16/2433

(57) ABSTRACT

Aspects of the subject disclosure may include, for example, validating data across database tables by comparing checksums across rows of the various tables. A client computing device may perform a database query to produce checksum values for one or more rows in one or more database tables to be compared. Checksums are compared and when mismatches are found, database table rows may be copied from one database table to another, or entire database tables may be copied. Other embodiments are disclosed.

### CROSS-REFERENCE TO RELATED APPLICATION(S)

The present application claims the benefit of priority to U.S. Provisional Application No. 63/622,661 filed on Jan. 19, 2024, which is hereby incorporated herein by reference in its entirety.

### FIELD OF THE DISCLOSURE

The subject disclosure relates to verifying data across database tables.

### BACKGROUND

Verifying that data matches across multiple database tables can consume varying amounts of resources based on many factors. For example, for very large databases (VLDB), a brute force comparison of every table and/or every record in a table can consume significant computing resources and time. Also, for example, when comparing data in two databases having different database formats, a simple file comparison may not produce valid results even when the data represented within the databases is the same.

### BRIEF DESCRIPTION OF THE DRAWINGS

Reference will now be made to the accompanying drawings, which are not necessarily drawn to scale, and wherein:

FIG. 1 is a block diagram illustrating example, non-limiting embodiments of a system functioning in accordance with various aspects described herein.

FIG. 2 is a block diagram of an example, non-limiting embodiment of a computing environment in accordance with various aspects described herein.

### DETAILED DESCRIPTION

One or more aspects of the subject disclosure include a non-transitory machine-readable medium, comprising executable instructions that, when executed by a client computing device including a processor, facilitate performance of operations. The operations may include requesting a first checksum of a first row of a first database table; receiving the first checksum; requesting a second checksum of a first row of a second database table; receiving the second checksum; comparing the first checksum and the second checksum; determining that the first checksum and the second checksum do not match; and copying the first row of the first database table to the first row of the second database table.

One or more aspects of the subject disclosure include a device, comprising a processing system including a processor and a memory that stores executable instructions that, when executed by the processing system, facilitate performance of operations. The operations may include requesting a database upgrade of a first database that includes a plurality of first database tables, wherein the requesting the database upgrade results in a plurality of second database tables; determining checksum values for at least one row of each of the plurality of first database tables; determining checksum values for a corresponding at least one row of the plurality of second database tables; and copying the at least one row of each of the plurality of first database tables to the corresponding at least one row of the plurality of second database tables when the checksum values for the at least one row and corresponding at least one row do not match.

One or more aspects of the subject disclosure include a method, comprising: requesting, by a processing system including a processor, a database upgrade of a first database that includes a plurality of first database tables, wherein the requesting the database upgrade results in a plurality of second database tables; determining, by the processing system, checksum values for at least one row of each of the plurality of first database tables; determining, by the processing system, checksum values for a corresponding at least one row of the plurality of second database tables; and copying, by the processing system, at least one table of each of the plurality of first database tables to a corresponding at least one row of the plurality of second database tables when at least one checksum associated with the at least one table and corresponding at least one table do not match.

Additional aspects of the subject disclosure may include performing a structured query language (SQL) query on a database to request the first checksum, wherein the database may be remote, located in a datacenter, in the cloud, or provided as a database as a service (DBaaS). The operations may further comprise generating a logfile showing table rows that have been copied in response to checksum mismatches. The operations may also include determining the checksum values for the at least one row of each of the plurality of first database tables by performing an SQL query on a database, which may be remote. Additionally, the operations may involve generating a logfile showing checksum mismatches and table rows that have been copied responsive to these mismatches. The method may further comprise copying the at least one table by performing an SQL query on a database, which may be remote, located in a datacenter, in the cloud, or provided as a DBaaS, and generating a logfile showing tables that have been copied in response to checksum mismatches.

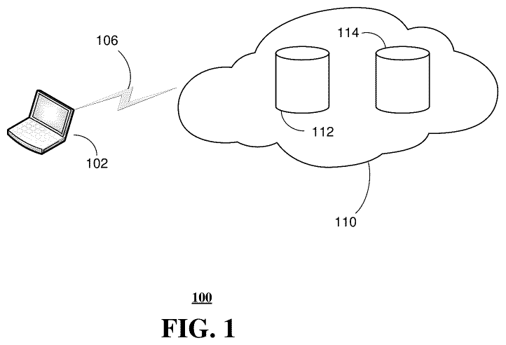

FIG. 1 is a block diagrams illustrating example, non-limiting embodiments of a system functioning in accordance with various aspects described herein.

Referring to FIG. 1, in one or more embodiments, a system 100 includes a client computing device 102, and a computing environment 110. Computing environment 110 in turn includes databases 112 and 114. In various embodiments, computing environment 110 may include any number or type of computing devices, such as servers, virtual machines, computers in a datacenter, cloud computing infrastructure, or any other type of computing resources capable of hosting a database product that can house databases 112 and 114. In some embodiments, databases 112 and 114 are very large databases (VLDBs), which may include many different types of data (e.g., text, numbers, XML, and unstructured data such as binary large objects (BLOBs).

Client computing device 102 may be any type of computing device that can communicate with computing environment 110 as shown at 106. The communications at 106 may be performed in any manner. For example, communications 106 may be on a local network, across the Internet, or any type of communication that allows client computing device 102 to communicate with computing environment 110.

In some embodiments, client computing device 102 communicates with computing environment 110 using database commands or other protocols understood by computing environment 110. For example, in some embodiments, client computing device 102 may communicate with computing environment 110 by performing structured query language (SQL) queries to fetch data from databases 112 and 114 or to modify data within databases 112 and 114.

In various embodiments, databases 112 and 114 may include one or more tables and/or one or more rows within one or more tables that should match. For example, in some embodiments, database 114 may be generated by performing a copy operation of database 112. In these embodiments, database 114 should match database 112 exactly since it was generated from a brute force copy operation. Also, for example, in some embodiments, database 114 may be generated by performing an update operation of database 112. An example of an update operation may include updating from one version of a database provider's tool to a newer version of the database provider's tool. In these embodiments, the data represented within database 114 should match the data represented within database 112; however, the exact file structure of database 114 may not match the exact file structure of database 112, in part because of the variations caused by different database versions.

In some embodiments, it may be advantageous to verify that the data represented within database 114 matches the data represented within database 112. For example, an update (or upgrade) operation may be performed within a maintenance window where database 112 is migrated to database 114, and prior to switching operations from database 112 to database 114, database 114 may be validated to verify that the data represented within database 114 matches the data represented within database 112.

For very large databases, and for databases separated by distances or communication protocols that introduce delays when communicating, directly comparing all of the data within database 114 to all of the data within database 112 may be prohibitively time consuming. For example, if databases 112 and 114 include hundreds of thousands of tables, and billions of rows, a brute force comparison operation may not be able to be performed within the required maintenance window. Also, for example, because the file structure of the physical files within databases 112 and 114 may not match exactly even when the data represented by the two databases does match, a simple file comparison between the two databases may not provide a valid result.

In various embodiments, client computing device 102 may verify that the data represented by database 114 matches the data represented by database 112 by requesting checksums for each row in each table of databases 112 and 114, and then comparing the checksums on a row by row and table by table basis. In some embodiments, when the checksums all match, the databases 112 and 114 have been verified to match. Also in some embodiments, when the checksums do not all match, client computing device 102 may perform one or more operations to cause the data represented by database 114 to match the data represented by database 112. For example, if a row within a table fails the checksum match, client computing device 102 may perform a row copy operation to copy the offending row from database 112 to database 114. Also, for example, if a row within a table fails the checksum match, client computing device 102 may perform a table copy operation to copy the entire offending table from database 112 to database 114.

In some embodiments, the decision whether to copy a single row or an entire table is made based on table size. For example, for small tables having a size below a particular threshold, the table copy operation may not consume much additional resources beyond that consumed by a single row copy operation. Further, if for a particular table, multiple rows fail the checksum comparison, a single table copy operation may be faster and consume fewer computing resources than multiple row copy operations.

In some embodiments, client computing device 102 may automate various tasks associated with validating the databases. For example, in some embodiments, client computing device 102 may employ scripting (e.g., Unix shell scripts), Python, or any other type of programmatic tool to automate one or more tasks. As an example, and not by way of limitation, client computing device 102 may, through an automated script, communicate with the database provider at computing environment 110 to iteratively request checksums for each row within each table of database 112 and to also iteratively request checksums for each row within each table of database 114. Client computing device 102 may then compare the corresponding checksums for each row within each table of the two databases, and then take one or more actions based on the result. For example, in some embodiments, client computing device 102 may produce a log file which shows which checksums match and which checksums do not match. Also, for example, in some embodiments, client computing device 102 may perform database operations as a result of the comparisons of the checksums. Various database operations include fetching rows of tables, writing rows of tables, fetching entire tables, writing entire tables, requesting copy operations, requesting deletion operations, or performing any other query of databases 112 and 114.

As an additional example, in some embodiments, a client computing device may request a first checksum of a first row of a first database table. This operation may be performed between the client computing device and a computing center (e.g., a datacenter or cloud infrastructure provider) that houses multiple databases. For example, client computing device 102 may perform a query or other database operation over communications link 106 to request that a checksum operation be performed. In response to the request, the client computing device may receive the first checksum. The client computing device may request a second checksum of a first row of a second database table, and then receive the second checksum. In various embodiments, the first database table may be a table within database 112, and the second database table may be a corresponding database table within database 114. Similarly, the first row of the second database table corresponds to the first row of the first database table.

Client computing device 102 may then compare the first checksum and the second checksum. After determining that the first checksum and the second checksum do not match, client computing device 102 may perform an operation. In some embodiments, the operation may include copying the first row of the first database table to the first row of the second database table. In other embodiments, the operation may include copying the first database table to the second database table. In some embodiments, the decision whether to copy a row or copy a table is made based on one or more factors. For example, if the table is below a particular threshold size, the entire table is copied when a checksum mismatch is found. Also in some embodiments, when more than one checksum mismatch is found within a single table, the entire table is copied rather than performing multiple row copy operations. In still further embodiments, the number of checksum mismatches within a particular table may be compared to a threshold, and when the number of checksum mismatches exceeds the threshold, the table copy operation is performed rather than multiple row copy operations.

In some embodiments, corrective actions are taken as soon as a checksum mismatch is found. For example, as checksums for corresponding rows within database 112 and 114 are produced and compared, a corrective action may be taken as soon as a mismatch is found. For example, a row may be copied immediately upon a checksum mismatch being found, and/or a table may be copied immediately upon a checksum mismatch being found. Also in some embodiments, corrective actions may be taken only after all checksums for all rows in a table have been compared. For example, checksums for rows within a first table within database 112 may be compared to checksums for rows within the corresponding first table within database 114 before any corrective action is taken. In these embodiments, the decision to make row by row copies or a complete table copy may be made after all checksums for all rows within the table have been compared.

In some embodiments, client computing device 102 may step through every row of every table and request checksums for each row. In some embodiments, this results in lists of checksums. A first list of checksums may be produced for tables within database 112, and a second list of checksums may be generated for tables within database 114. In these embodiments, the checksum lists may be compared in bulk before any actions are taken to correct mismatches.

In some embodiments, client computing device 102 may request a database upgrade of a first database that includes the first plurality of first database tables wherein the requesting the database upgrade results in a second database that includes a plurality of second database tables. In these embodiments, client computing device 102 may continue the operations as described herein to verify the upgrade from the first database tables to the second database tables.

In some embodiments, at least one of the operations described herein (e.g., requesting checksum(s), copying rows, copying tables, etc.) may include performing a structured query language (SQL) query on a database. The database may be located anywhere relative to the client computing device performing the query. For example, the database may be local to the client computing device, or may be remote as compared to the client computing device. Also, for example, the database may be located in a data center or in the cloud. Further, the database may be provided as a database as a service (DBaaS).

In some embodiments, database tables are grouped to form groups of database tables. The database tables may be grouped based on any criteria. For example, a database group may be formed based on table size. Tables having a size below a particular threshold may be placed in a first group and tables having sizes above the particular threshold may be placed in a second group. Also, for example, a database group may be formed based on the type of data within tables. Tables having highly structured data may be placed in a first group and tables having unstructured data may be placed in a second group. Various embodiments described herein may perform different operations on tables in the various groups. For example, when mismatches are found in tables in the first group, table copy operations may be automatically applied. In this example, a table copy operation may be performed upon discovering the first checksum mismatch in a table, thereby obviating the need to perform further check some fetches and comparisons for the remainder of the table. Also, for example, the number of parallel operations (EG, threads, agents, etcetera) may be different for tables in the first group versus tables in the second group. For example, a larger number of threads may be utilized to perform checksum fetches and comparisons for large tables as compared to a number of threads that may be utilized to perform checksum fetches and comparisons for smaller tables. Any number of groups of tables may be formed, and groupings may be performed based on a single criterion or multiple criteria.

In some embodiments, the number or type of operations may be modified based on the number of tables in different groups, or as verification operations are completed for tables in different groups. For example, if a verification operation that utilizes a large number of parallel operations for large table verification is completed, the number of parallel operations utilized for verification operations for smaller tables may be increased.

In some embodiments, the number of parallel operations at the client computing device 102 may be different than the number of parallel operations at computing environment 110. For example, a single thread at computing device 102 may perform multiple operations that results in multiple parallel operations being performed at computing environment 110. In some embodiments that number of parallel operations performed by computing device 102 are the same as the number of parallel operations being performed at computing environment 110, and in other embodiments the number of parallel operations are not the same.

In some embodiments, one or more operations described herein are performed as a result of a failed test. For example, a performance verification test after a database upgrade may yield a data integrity problem with the upgraded database. In response to the failed test, the upgraded database may be verified using the checksum comparison embodiments described herein.

As an example, and not by way of limitation, a version upgrade of an Oracle database (e.g., from version 12c to version 19c) may be performed using Oracle's Golden Gate Migration Tool. It is possible to identify data integrity issues between the source database (e.g., database 112) and the target database (e.g., database 114). When this happens, the source of the mismatch of data between the source and target databases may not be available (e.g., when performance verification testing is confined to certain critical tables). A successful migration may be had by comparing objects by object, record by record, byte by byte to ensure either no discrepancies, or if discrepancies are identified, it presents an opportunity to copy the tables from the source database to the target database.

Various embodiments use a Python Script to perform bulk fetches using multiple threads across more than 20,000 tables with 1.5 billion rows to compare and show the difference between source and target databases. The script does a checksum on the entire row in the database and only fetches the checksum value. That way the whole record is not fetched hence making the process much more efficient and less network contention. This enabled verification of the database upgrade within the maintenance window which was a key success indicator for this implementation.

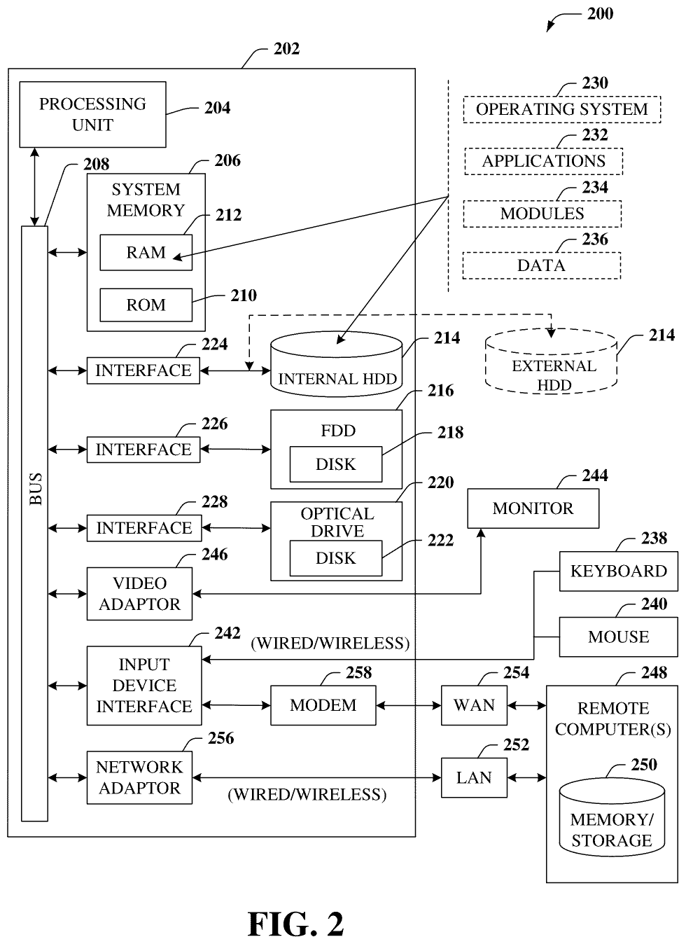

Turning now to FIG. 2, there is illustrated a block diagram of a computing environment in accordance with various aspects described herein. In order to provide additional context for various embodiments of the embodiments described herein, FIG. 2 and the following discussion are intended to provide a brief, general description of a suitable computing environment 200 in which the various embodiments of the subject disclosure can be implemented. In particular, the computing environment 200 can be used in computing device described herein. Each of these devices can be implemented via computer-executable instructions that can run on one or more computers, and/or in combination with other program modules and/or as a combination of hardware and software. For example, computing environment 200 can facilitate in whole or in part the validation of database tables via checksum comparisons. Further, each of the client computing device 102, or any of the computing devices within computing environment 110.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 2, the example environment can comprise a computer 202, the computer 202 comprising a processing unit 204, a system memory 206 and a system bus 208. The system bus 208 couples system components including, but not limited to, the system memory 206 to the processing unit 204. The processing unit 204 can be any of various commercially available processors. Dual microprocessors and other multiprocessor architectures can also be employed as the processing unit 204.

The system bus 208 can be any of several types of bus structure that can further interconnect to a memory bus (with or without a memory controller), a peripheral bus, and a local bus using any of a variety of commercially available bus architectures. The system memory 206 comprises ROM 210 and RAM 212. A basic input/output system (BIOS) can be stored in a non-volatile memory such as ROM, erasable programmable read only memory (EPROM), EEPROM, which BIOS contains the basic routines that help to transfer information between elements within the computer 202, such as during startup. The RAM 212 can also comprise a high-speed RAM such as static RAM for caching data.

The computer 202 further comprises an internal hard disk drive (HDD) 214 (e.g., EIDE, SATA), which internal HDD 214 can also be configured for external use in a suitable chassis (not shown), a magnetic floppy disk drive (FDD) 216, (e.g., to read from or write to a removable diskette 218) and an optical disk drive 220, (e.g., reading a CD-ROM disk 222 or, to read from or write to other high-capacity optical media such as the DVD). The HDD 214, magnetic FDD 216 and optical disk drive 220 can be connected to the system bus 208 by a hard disk drive interface 224, a magnetic disk drive interface 226 and an optical drive interface 228, respectively. The hard disk drive interface 224 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 202, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 212, comprising an operating system 230, one or more application programs 232, other program modules 234 and program data 236. All or portions of the operating system, applications, modules, and/or data can also be cached in the RAM 212. The systems and methods described herein can be implemented utilizing various commercially available operating systems or combinations of operating systems.

A user can enter commands and information into the computer 202 through one or more wired/wireless input devices, e.g., a keyboard 238 and a pointing device, such as a mouse 240. Other input devices (not shown) can comprise a microphone, an infrared (IR) remote control, a joystick, a game pad, a stylus pen, touch screen or the like. These and other input devices are often connected to the processing unit 204 through an input device interface 242 that can be coupled to the system bus 208, but can be connected by other interfaces, such as a parallel port, an IEEE 1394 serial port, a game port, a universal serial bus (USB) port, an IR interface, etc.

A monitor 244 or other type of display device can be also connected to the system bus 208 via an interface, such as a video adapter 246. It will also be appreciated that in alternative embodiments, a monitor 244 can also be any display device (e.g., another computer having a display, a smart phone, a tablet computer, etc.) for receiving display information associated with computer 202 via any communication means, including via the Internet and cloud-based networks. In addition to the monitor 244, a computer typically comprises other peripheral output devices (not shown), such as speakers, printers, etc.

The computer 202 can operate in a networked environment using logical connections via wired and/or wireless communications to one or more remote computers, such as a remote computer(s) 248. The remote computer(s) 248 can be a workstation, a server computer, a router, a personal computer, portable computer, microprocessor-based entertainment appliance, a peer device or other common network node, and typically comprises many or all of the elements described relative to the computer 202, although, for purposes of brevity, only a remote memory/storage device 250 is illustrated. The logical connections depicted comprise wired/wireless connectivity to a local area network (LAN) 252 and/or larger networks, e.g., a wide area network (WAN) 254. Such LAN and WAN networking environments are commonplace in offices and companies, and facilitate enterprise-wide computer networks, such as intranets, all of which can connect to a global communications network, e.g., the Internet.

When used in a LAN networking environment, the computer 202 can be connected to the LAN 252 through a wired and/or wireless communication network interface or adapter 256. The adapter 256 can facilitate wired or wireless communication to the LAN 252, which can also comprise a wireless AP disposed thereon for communicating with the adapter 256.

When used in a WAN networking environment, the computer 202 can comprise a modem 258 or can be connected to a communications server on the WAN 254 or has other means for establishing communications over the WAN 254, such as by way of the Internet. The modem 258, which can be internal or external and a wired or wireless device, can be connected to the system bus 208 via the input device interface 242. In a networked environment, program modules depicted relative to the computer 202 or portions thereof, can be stored in the remote memory/storage device 250. It will be appreciated that the network connections shown are example and other means of establishing a communications link between the computers can be used.

The computer 202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A non-transitory machine-readable medium, comprising executable instructions that, when executed by a client computing device including a processor, facilitate performance of operations, the operations comprising:
requesting a first checksum of a first row of a first database table;
receiving the first checksum;
requesting a second checksum of a first row of a second database table;
receiving the second checksum;
comparing the first checksum and the second checksum;
determining that the first checksum and the second checksum do not match; and
copying the first row of the first database table to the first row of the second database table.

2. The non-transitory machine-readable medium of claim 1, wherein the requesting the first checksum includes performing a structured query language (SQL) query on a database.

3. The non-transitory machine-readable medium of claim 1, wherein the requesting the first checksum includes performing a structured query language (SQL) query on a remote database.

4. The non-transitory machine-readable medium of claim 1, wherein the requesting the first checksum includes performing a structured query language (SQL) query on a database located in a datacenter.

5. The non-transitory machine-readable medium of claim 1, wherein the requesting the first checksum includes performing a structured query language (SQL) query on a database located in the cloud.

6. The non-transitory machine-readable medium of claim 1, wherein the requesting the first checksum includes performing a structured query language (SQL) query on a database provided as a database as a service (DBaaS).

7. The non-transitory machine-readable medium of claim 1, the operations further comprising generating a logfile showing table rows that have been copied responsive to checksum mismatches.

8. A device, comprising:
a processing system including a processor; and
a memory that stores executable instructions that, when executed by the processing system, facilitate performance of operations, the operations comprising performing any combination of the operations described above;
requesting a database upgrade of a first database that includes a plurality of first database tables, wherein the requesting the database upgrade results in a plurality of second database tables;
determining checksum values for at least one row of each of the plurality of first database tables;
determining checksum values for a corresponding at least one row of the plurality of second database tables; and
copying the at least one row of each of the plurality of first database tables to the corresponding at least one row of the plurality of second database tables when the checksum values for the at least one row and corresponding at least one row do not match.

9. The device of claim 8, wherein the determining the checksum values for the at least one row of each of the plurality of first database tables includes performing a structured query language (SQL) query on a database.

10. The device of claim 8, wherein the determining the checksum values for the at least one row of each of the plurality of first database tables includes performing a structured query language (SQL) query on a remote database.

11. The device of claim 8, the operations further comprising generating a logfile showing checksum mismatches.

12. The device of claim 8, the operations further comprising generating a logfile showing table rows that have been copied responsive to checksum mismatches.

13. The device of claim 8, wherein the determining the checksum values for the at least one row of each of the plurality of first database tables includes performing a structured query language (SQL) query on a database.

14. A method, comprising:
requesting, by a processing system including a processor, a database upgrade of a first database that includes a plurality of first database tables, wherein the requesting the database upgrade results in a plurality of second database tables;
determining, by the processing system, checksum values for at least one row of each of the plurality of first database tables;
determining, by the processing system, checksum values for a corresponding at least one row of the plurality of second database tables; and
copying, by the processing system, at least one table of each of the plurality of first database tables to a corresponding at least one row of the plurality of second database tables when at least one checksum associated with the at least one table and corresponding at least one table do not match.

15. The method of claim 14, wherein the copying the at least one table includes performing a structured query language (SQL) query on a database.

16. The method of claim 14, wherein the copying the at least one table includes performing a structured query language (SQL) query on a remote database.

17. The method of claim 14, wherein the copying the at least one table includes performing a structured query language (SQL) query on a database located in a datacenter.

18. The method of claim 14, wherein the copying the at least one table includes performing a structured query language (SQL) query on a database located in the cloud.

19. The method of claim 14, wherein the copying the at least one table includes performing a structured query language (SQL) query on a database provided as a database as a service (DBaaS).

20. The method of claim 14, further comprising generating, by the processing system, a logfile showing tables that have been copied responsive to checksum mismatches.
